(19) United States
(12) Patent Application Publication
(10) Pub. No.: US 2026/0206093 A1
(43) Pub. Date: Jul. 16, 2026

(54) ALIGNING USER EQUIPMENT (UE) DISCONTINUOUS RECEPTION (DRX) TO CELL DISCONTINUOUS TRANSMISSION (DTX)

(71) Applicant: LENOVO (SINGAPORE) PTE. LTD., Singapore (SG)

(72) Inventors: Prateek BASU MALLICK, Dreieich (DE); Joachim LÖHR, Wiesbaden (DE); Ravi KUCHIBHOTLA, Chicago, IL (US)

(21) Appl. No.: 19/134,036

(22) PCT Filed: Feb. 8, 2024
(86) PCT No.: PCT/IB2024/051180

§ 371 Date: May 29, 2025

Related U.S. Application Data
(60) Provisional application No. 63/484,291, filed on Feb. 10, 2023.

(51) Int. Cl. H04W 76/28; H04W 52/02

(52) U.S. Cl. CPC H04W 76/28; H04W 52/0235

(57) ABSTRACT

Various aspects of the present disclosure relate to reducing energy consumption in wireless communication systems. For example, a network can realize scenarios where a cell (e.g., a serving cell) can perform techniques that reconfigure all RRC Connected UE DRX Cycles or Modes, without having to individually send a dedicated reconfiguration to each of the UEs. The network can align DRX reception at UEs to the DTX of an associated cell or network entity, such as a serving cell.

### CROSS REFERENCE TO RELATED APPLICATIONS

This application claims priority to U.S. Provisional Patent Application No. 63/484,291, filed on Feb. 10, 2023, entitled ALIGHING USER EQUIPMENT (UE) DISCONTINUOUS RECEPTION (DRX) TO CELL DISCONTINUOUS TRANSMISSION (DTX), which is hereby incorporated by reference in its entirety.

### TECHNICAL FIELD

The present disclosure relates to wireless communications, and more specifically to aligning user equipment (UE) discontinuous reception (DRX) to cell/network discontinuous transmission (DTX).

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

While the adoption of 5G and technologies beyond 5G enables wireless communications systems to provide enhanced services at high data rates, these enhanced services often rely on denser networks, such as networks having an increasing number of cell sites and/or antennas, larger bandwidths, additional frequency bands, and so on. Further, as the number of devices and services increase, the potential environmental impact and operating costs due to device emissions and energy consumption can also increase, among other unintended drawbacks.

In some cases, a network can realize energy savings by implementing cell discontinuous transmission (DTX) or discontinuous reception (DRX). During cell DTX/DRX, the serving cell behavior, during non-active period or times, can include: a gNB turning off all transmission and reception for data traffic and reference signals; the gNB turns off its transmission/reception only for data traffic (and still transit/receive reference signals); the gNB turns off its dynamic data transmission/reception (and still perform transmission/reception in periodic resources); and/or the gNB only transmits reference signals.

### SUMMARY

The present disclosure relates to methods, apparatuses, and systems that support reducing energy consumption in a wireless communications system by configuring a UE to align its DRX modes with the DTX modes of a network or associated cell. For example, when a cell decides to save energy (e.g., act like a Network Energy Saving (NES) cell) and follow a cell DTX configuration, the cell or network can perform various actions to reconfigure all RRC Connected UEs to align their DRX configurations to the cell DTX configuration.

Some implementations of the method and apparatuses described herein may further include a UE for wireless communication, comprising at least one memory and at least one processor coupled with the at least one memory and configured to cause the network entity to receive, from a serving cell, a first DRX configuration, apply the first DRX configuration, and receive, from the serving cell, an indication that the serving cell has transitioned to DTX.

In some implementations of the method and apparatuses described herein, the processor is further configured to cause the UE to receive a second DX configuration from the serving cell and apply the second DRX configuration in response to the indication.

In some implementations of the method and apparatuses described herein, the processor is further configured to cause the UE to receive, from the serving cell, a network energy saving scenario configuration that indicates a DTX configuration for the serving cell.

In some implementations of the method and apparatuses described herein, the UE is in a radio resource control (RRC) connected state.

In some implementations of the method and apparatuses described herein, the UE receives the first DRX configuration and the second DRX configuration via a single RRC signaling message.

In some implementations of the method and apparatuses described herein, the first DRX configuration and the second DRX configuration identifies a time period during which the UE is to be in an active reception mode.

In some implementations of the method and apparatuses described herein, UE receives the indication that the serving cell has transitioned to DTX via physical layer signaling or a medium access control (MAC) control element (CE).

In some implementations of the method and apparatuses described herein, the physical layer signaling triggers a start of one or more time periods in which the serving cell is in a non-active transmission mode.

In some implementations of the method and apparatuses described herein, applying the second DRX configuration includes not following the first DRX configuration when the serving cell is in a non-active transmission mode.

Some implementations of the method and apparatuses described herein may further include a method performed by a UE, the method comprising receiving, from a serving cell, a first DRX configuration, applying the first DRX configuration, and receiving, from the serving cell, an indication that the serving cell has transitioned to DTX.

In some implementations of the method and apparatuses described herein, the method further comprises receiving a second DX configuration from the serving cell and applying the second DRX configuration in response to the indication.

In some implementations of the method and apparatuses described herein, the method further comprises receiving, from the serving cell, a network energy saving scenario configuration that indicates a DTX configuration for the serving cell.

In some implementations of the method and apparatuses described herein, the UE is in an RRC connected state.

In some implementations of the method and apparatuses described herein, the UE receives the first DRX configuration and the second DRX configuration via a single RRC signaling message.

Some implementations of the method and apparatuses described herein may further include a processor for wireless communication, comprising at least one controller coupled with at least one memory and configured to cause the processor to receive, from a serving cell, a first DRX configuration, apply the first DRX configuration, and receive, from the serving cell, an indication that the serving cell has transitioned to DTX.

In some implementations of the method and apparatuses described herein, the controller is configured to cause the processor to receive a second DX configuration from the serving cell and apply the second DRX configuration in response to the indication.

In some implementations of the method and apparatuses described herein, the controller is further configured to cause the processor to receive, from the serving cell, a network energy saving scenario configuration that indicates a DTX configuration for the serving cell.

In some implementations of the method and apparatuses described herein, the processor is in an RRC connected state.

In some implementations of the method and apparatuses described herein, the first DRX configuration and the second DRX configuration via a single RRC signaling message.

Some implementations of the method and apparatuses described herein may further include a network entity, comprising at least one memory and at least one processor coupled with the at least one memory and configured to cause the network entity to determine a DTX configuration, transmit to one or more UEs a network energy saving scenario configuration that is based on the DTX configuration, determine a DRX configuration for the one or more UEs, and transmit to the one or more UEs the first DRX configuration.

In some implementations of the method and apparatuses described herein, the processor configured to cause the network entity to transmit to the one or more UEs physical layer signaling to trigger starts of time periods when the network entity is in a non-active transmission mode based on the DTX configuration.

In some implementations of the method and apparatuses described herein, the second DRX configuration is based on the DTX configuration of the network entity.

In some implementations of the method and apparatuses described herein, the network entity transmits the first DRX configuration and the second DRX configuration via a single RRC signaling message.

Some implementations of the method and apparatuses described herein may further include a method performed by a network entity, the method comprising determining a DTX configuration, transmitting to one or more UEs a network energy saving scenario configuration that is based on the DTX configuration, determining a first DRX configuration and a second DRX configuration for the one or more UEs, and transmitting to the one or more UEs the first DRX configuration and the second DRX configuration.

In some implementations of the method and apparatuses described herein, the processor configured to cause the network entity to determine a second DRX configuration for the one or more UEs and transmit to the one or more UEs the second DRX configuration.

In some implementations of the method and apparatuses described herein, the method further comprises transmitting, to the one or more UEs, physical layer signaling to trigger starts of time periods when the network entity is in a non-active transmission mode based on the DTX configuration.

In some implementations of the method and apparatuses described herein, the second DRX configuration is based on the DTX configuration of the network entity.

In some implementations of the method and apparatuses described herein, the network entity transmits the first DRX configuration and the second DRX configuration via a single RRC signaling message.

### BRIEF DESCRIPTION OF THE DRAWINGS

FIG. 1 illustrates an example of a wireless communications system that supports optimizing UE behaviors during cell DRX modes in accordance with aspects of the present disclosure.

FIG. 2 illustrates an example of a diagram that supports alignment of a cell DTX mode and UE DRX modes in accordance with aspects of the present disclosure.

FIG. 3 illustrates an example of a diagram that supports automatic alignment of UE DRX to cell DTX in accordance with aspects of the present disclosure.

FIG. 4 illustrates an example of a block diagram of a device that supports aligning UE DRX to cell/network DTX in accordance with aspects of the present disclosure.

FIG. 5 illustrates a flowchart of a method that supports modification of a UE DRX configuration in accordance with aspects of the present disclosure.

FIG. 6 illustrates a flowchart of a method that supports providing UE DRX configurations in accordance with aspects of the present disclosure.

### DETAILED DESCRIPTION

While the implementation of a network energy consumption model can significantly enable a network to realize energy savings, such a model can adversely impact operations and performance of various devices of the network, such as cells (e.g., base stations) and UEs. For example, when a network employs DTX for one or more serving cells, the UEs associated with the serving cells may waste energy and resources when remaining in active reception modes (e.g., not in DRX).

To mitigate such drawbacks, a UE can be configured to align its DRX modes with the DTX modes of a network or associated cell. For example, when a cell decides to save energy (e.g., act like a NES cell) and follow a cell DTX configuration, the cell or network can perform various actions to reconfigure all RRC Connected UEs to align their DRX configurations to the cell DTX configuration.

In doing so, the network or cell can inform the UEs of the network/cell DTX configuration without having to individually send a dedicated reconfiguration to each of the UEs, saving resources and preventing unnecessary messaging, among other benefits.

Aspects of the present disclosure are described in the context of a wireless communications system. Aspects of the present disclosure are further illustrated and described with reference to device diagrams and flowcharts.

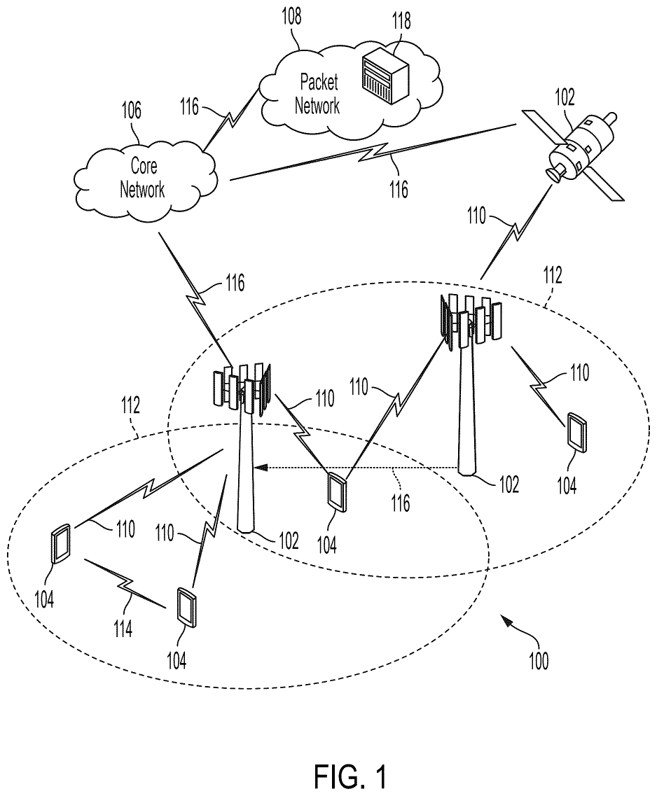

FIG. 1 illustrates an example of a wireless communications system 100 that supports UE behaviors during cell DRX modes in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUsor RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU 160.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers)) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., M=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHZ-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

As described herein, in some embodiments, a network or cell (e.g., a serving cell) can activate a DTX/DRX configuration. For example, a cell DTX/DRX mode can be activated/de-activated via dynamic L1/L2 signaling and UE-specific RRC signaling. Both UE specific and common L1/L2 signaling can be utilized to activate/de-activate the cell DTX/DRX mode.

When access stratum (AS) receives the cell DTX/DRX information from the network, the AS informs Non-Access Stratum (NAS) of the DTX/DRX time of the network, and the NAS, based on the DTX/DRX time, supervises a NAS procedure (e.g., a registration (update), service requests, and so on). Thus, the network applies cell DTX/DRX in a time domain, such as with UEs in an RRC_CONNECTED state. For example, a gNB can configure a periodic cell DTX/DRX, and the gNB can configure a serving cell using UE-specific RRC signaling.

Further, a network can separately configure cell DTX and cell DRX modes (e.g., one RRC configuration set for DL (downlink) and another for UL) or can be configured together. The following parameters, among other parameters, can be part of the cell DTX/DRX configuration: periodicity, start slot/offset, on duration, and so on.

As described herein, the network can realize scenarios where a cell (e.g., a serving cell) can perform techniques that reconfigure all RRC Connected UE DRX Cycles or Modes, without having to individually send a dedicated reconfiguration to each of the UEs. Thus, the network can align DRX reception at UEs to the DTX of an associated cell or network entity, such as a serving cell, among other benefits.

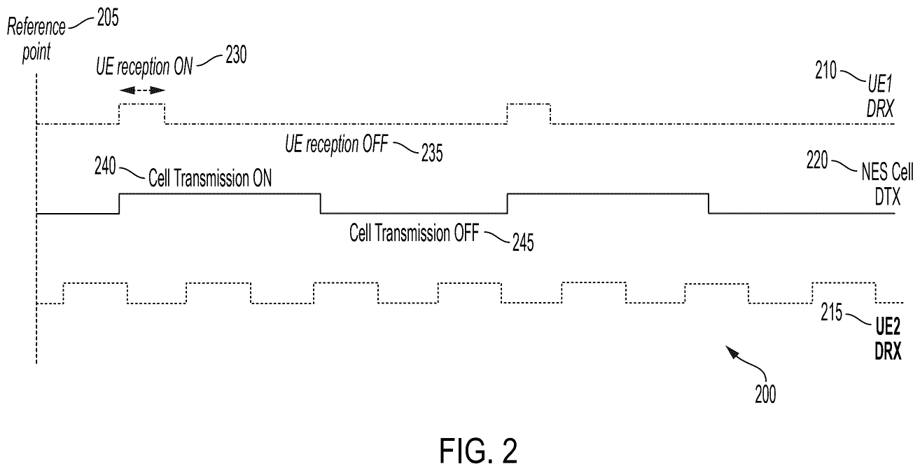

FIG. 2 illustrates an example of a diagram 200 that supports the alignment of a cell DTX mode and UE DRX modes in accordance with aspects of the present disclosure. The diagram 200 includes a first UE (e.g., RRC Connected UE1) having a first DRX configuration 210 and a second UE (e.g., RRC Connected UE2) having a second DRX configuration 215. The DRX configuration identifies UE reception states, such as a UE reception ON state 230 (e.g., when the UE1 is actively receiving data traffic and/or reference signals), and a UE reception OFF state 235 (e.g., when the UE1 is inactive for reception of data traffic and/or reference signals).

Similarly, a (Network Energy Saving) NES cell has a DTX configuration 220, such as when the cell is in an energy saving mode that utilizes DTX. The DTX configuration 220 for the cell can include a cell transmission ON state 240 (e.g., when the cell is actively transmitting data traffic and/or reference signals) and a cell transmission OFF state 245 (e.g., when the cell is inactive for transmission of data traffic and/or reference signals). Thus, cell DTX (or network DTX) can refer to a non-active or non-transmission state, such as a blanket absence of transmitting any DL traffic/signals to the UEs. Based on a reference point 205, the UEs and the cell can align their DRX and DTX configurations.

In some embodiments, the NES cell or radio network can broadcast its energy saving scenario (e.g., DTX configuration) to associated UEs. For example, the cell can broadcast different information elements (IEs), such as:

A. A two (or more) bits long index, as represented in Table 1 or Table 2:

TABLE 1

| Index | Channels or Transmission affected during Cell DTX/DRX |
|---|---|
| value | non-active periods |
| 1 | no transmission of data traffic and reference signal |
| 2 | no transmission of only data traffic (reference signal |
| | transmitted) |
| 3 | no transmission of dynamic data transmission (periodic |
| | traffic and reference signal transmitted) |
| 4 | only transmit reference signals and everything else is |
| | not transmitted |

TABLE 2

| Index | Channels or Transmission affected during Cell DTX/DRX |
|---|---|
| value | non-active periods |
| 1 | Only SSB transmission is made |
| 2 | Only SSB and MIB transmission is made |
| 3 | Only SSB, MIB and SIB1 transmission is made |
| 4 | Only SSB, MIB and SIB1 transmission is made but with |
| | a reduced periodicity compared with legacy |
| 5 | One of the above (particular one to be put in this |
| | row) + paging |
| 6 | One of the above (particular one to be put in this |
| | row) + data |

B. A one-bit Boolean flag indicating if the cell is receiving continuously or using a DRX pattern. Alternatively, the Boolean flag can indicate if the DRX pattern (e.g., DRX configuration) is same as its DTX pattern (e.g., DTX configuration).

C. A DTX and/or DRX pattern containing offset information from a reference point, such as slot/subframe #0 of SFN #0 or from the start of next modification period boundary. As defined in TS 38.331, a modification period is used, e.g., and an updated system information (SI) message (other than SI message for Earthquake and Tsunami Warning System (ETWS), Commercial Mobile Alert Service (CMAS), positioning assistance data, and some NTN-specific information as specified in the field descriptions) is broadcast in the modification period following the period where SI change indication is transmitted. The modification period boundaries can be defined by SFN values for which Subframe Number (SFN) mod m=0, where m is the number of radio frames that make up the modification period. The modification period can be configured by system information. If Hyper SFN (H-SFN) is provided in (system information block) SIB1, and UE is configured with (extended DRX) eDRX, modification period boundaries are defined by SFN values, for which (H-SFN*1024+SFN) mod m=0.

In some embodiments, the network can utilize paging configurations, such as a configuration having a normal cell transmission time, and a second configuration for cell DTX time. For example, the cell DTX time configuration may only allow for sporadic paging occasions, delaying a UE's paging reception, but saving energy for the network. The second configuration (e.g., PCCH-Config2) may indicate one or more configured values of IEs that are different from a first, or normal cell transmission time, paging configuration (e.g., PCCH-Config1) e.g., defaultPagingCycle, nAndPagingFrameOffset, ns, firstPDCCH-MonitoringOccasionOfPO, and so on. In some cases, the parameters not provided for PCCH-Config2 can be taken from PCCH-Config1.

Further, a RRC Connected UE can attempt to receive DL transmissions, such as by monitoring a UE specific search space using a Cell Radio Network Temporary Identifier (C-RNTI) during idle mode paging occasions calculated as if they were in an RRC Idle state (according to TS 38.304).

In some embodiments, the UE does not transmit when the cell is in DTX, although the cell can receive (e.g., in an active reception mode). The cell cannot transmit (e.g., feedback, dynamic grant, SSB/RS, and so on), and thus the UE may also not transmit when the cell is in DTX.

For example, each RRC Connected UE receives (via signaling) a first DRX-Config (e.g., from a MAC entity). Further, the network determines a DTX configuration in advance (e.g., before activating an NES mode). Each UE receives a second DRX-Config applicable for cases when energy saving will be activated, and the first DRX-Config and the second DRX-Config are both sent together to the UE using dedicated RRC signaling.

For example, the network sends a L1/L2 signaling common to all RRC Connected UEs, on a new common RNTI/Search Space, indicating that the network is transitioning (or will be transitioning) to energy saving mode. The UE can apply the second DRX-Config and stop using the first configuration when it receives the L1/L2 signaling indicating that the network is transitioning to energy saving mode.

In some cases, the L1/L2 signaling can indicate a future point in time when the second DRX-Config is to be activated; such as indication can also be done implicitly using the “modification period” technique described herein.

In some embodiments, the network can transmit a cell DTX configuration to the UE using RRC signaling (e.g., broadcast or dedicated signaling). The UE keeps transmitting (e.g., using a Configured Grant (CG) configuration), even when the cell is in DTX. A (configurable) fixed number of UL retransmissions can be used when the last retransmission falls inside of the cell DTX time. Upon last retransmission, the New Data Indication (NDI) is considered toggled, and a Hybrid Automatic Repeat Request (HARQ) buffer is flushed. Otherwise, such as when at least one retransmission would be performed during the network's non-DTX time, the UE stops making retransmissions when the cell is about to leave DTX (and can therefore transmit or respond).

In some cases, the network can configure such a technique on a per bearer basis. For example, when, for a certain bearer, the fixed retransmissions feature is not configured, the bearer is considered suspended. For a suspended bearer, the MAC entity also considers its buffer for data volume calculation. In some cases, the MAC entity does not consider a suspended bearer's buffer for data volume calculation or, the UE implementation can define how the UE calculates the data volume for the suspended RBs.

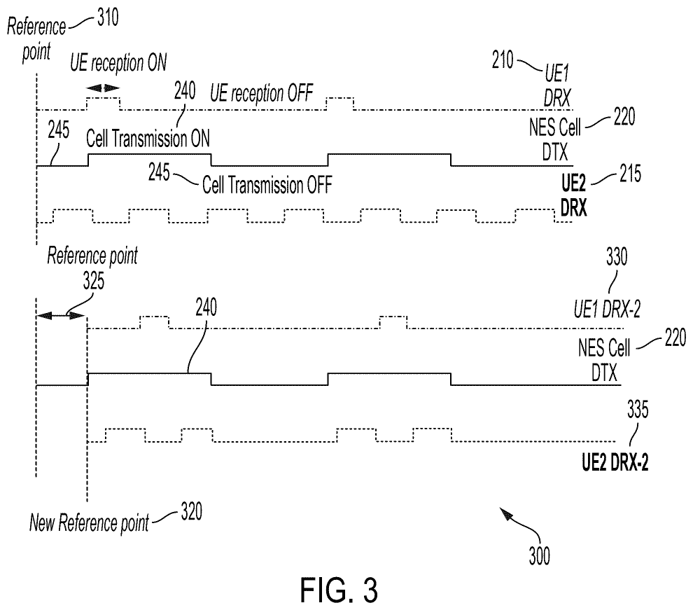

In some embodiments, the UE DRX is automatically aligned with the cell DTX. FIG. 3 illustrates an example of a diagram 300 that supports automatic alignment of UE DRX to cell DTX in accordance with aspects of the present disclosure.

For example, a reference point 310 for the UE1 DRX 210 (e.g., a DRX offset) is aligned with the cell transmission OFF mode 245 of the cell DTX 220. Next, the reference point is shifted to a new reference point 320 (e.g., with a time shift 325) for the UEs, to align with the cell transmission ONN mode 240 of the cell DTX 220.

In some cases, such as in addition to the shift 325 of the reference point 320, the actual active time of the UE can be derived from a superimposition (e.g., time period when the reception of the UE as well as cell transmission modes are “ON”) of the two configurations (e.g., cell DTX and UE DRX), as shown in the Figure.

In some embodiments, the network can create or generate multiple groups of RRC Connected UEs, where each group is associated with its own RNTI/search space/CORESET. L1/L2 signaling addressed to each group contains an additional DRX configuration, applicable to the receiving UEs. The additional DRX configuration for a certain group of UEs can be updated by: an additional DRX configuration being released or updated using another L1/L2 signaling sent at a later time, an additional DRX configuration being released or updated using an explicit indication in the first L1/L2 signaling, and so on.

In some cases, a network configures two DRX configurations using dedicated RRC signaling to each UE of a group of UEs. The UEs utilize the first configuration until the network activates a cell DTX configuration, which is signaled and activated using L1/L2 signaling to the group of UEs. Once the cell DTX configuration is activated, each UE of the UE group stops using the first DRX configuration and instead applies the second DRX configuration. In some cases, both the first DRX configuration and the second DRX configuration (or one of the DRX configurations) may be specific to each UE.

In some cases, only a first UE specific DRX configuration is sent to each UE using dedicated RRC signaling. The first DRX configuration is to be used until the network activates a cell DTX configuration. The cell DTX configuration activation signaling addresses the group of UEs and includes a group common second DRX configuration. The network can utilize L1/L2 signaling, such as a MAC CE, to the group of UEs. Once the cell DTX configuration is activated, each UE of the UE group stops using the first DRX configuration and instead applies the second DRX configuration.

In some embodiments, the network can align a “modification period” and the DTX configuration. For example, when the validity/lifetime of a DTX configuration ends with the modification period, a UE verifies that a DTX configuration may change in the new Modification Period or not (e.g., using a direct indication in SIB1). The network, therefore, can flexibly control the DTX configurations without requiring additional signaling. The UEs check SI validity (e.g., by receiving Value-Tag in each Modification Period). Further, the SIB1 may explicitly indicate if the DTX configuration from the previous modification period is still valid. When no longer valid, the UE can acquire the new DTX configuration, which could be broadcast in the SIB1 or in another SIB (a list of SIBs broadcasted in 5G NR can be found in TS 38.300 or in TS 38.331).

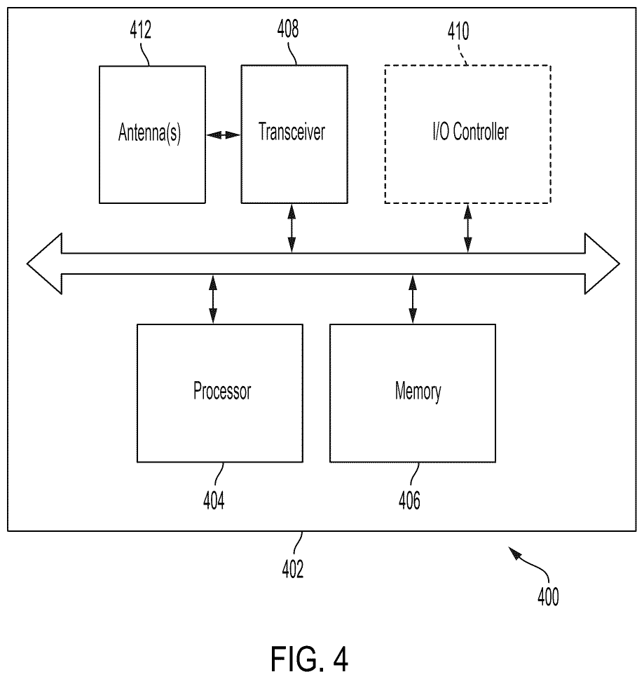

FIG. 4 illustrates an example of a block diagram 400 of a device 402 that supports aligning UE DRX to cell/network DTX in accordance with aspects of the present disclosure. The device 402 may be an example of a network entity 102 or UE 104 as described herein. The device 402 may support wireless communication with one or more network entities 102, UEs 104, or any combination thereof. The device 402 may include components for bi-directional communications including components for transmitting and receiving communications, such as a processor 404, a memory 406, a transceiver 408, and an I/O controller 410. These components may be in electronic communication or otherwise coupled (e.g., operatively, communicatively, functionally, electronically, electrically) via one or more interfaces (e.g., buses).

The processor 404, the memory 406, the transceiver 408, or various combinations thereof or various components thereof may be examples of means for performing various aspects of the present disclosure as described herein. For example, the processor 404, the memory 406, the transceiver 408, or various combinations or components thereof may support a method for performing one or more of the operations described herein.

In some implementations, the processor 404, the memory 406, the transceiver 408, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 404 and the memory 406 coupled with the processor 404 may be configured to perform one or more of the functions described herein (e.g., executing, by the processor 404, instructions stored in the memory 406).

For example, the processor 404 may support wireless communication at the device 402 in accordance with examples as disclosed herein. The processor 404 may be configured as or otherwise support a means for receiving, from a serving cell, a first DRX configuration, applying the first DRX configuration, and receiving, from the serving cell, an indication that the serving cell has transitioned to DTX.

As another example, the processor 404 may support wireless communication at the device 402 in accordance with examples as disclosed herein. The processor 404 may be configured as or otherwise support a means for determining a DTX configuration, transmitting to one or more UEs a network energy saving scenario configuration that is based on the DTX configuration, determining a first DRX configuration for the one or more UEs, and transmitting to the one or more UEs the first DRX configuration.

The processor 404 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 404 may be configured to operate a memory array using a memory controller. In some other implementations, a memory controller may be integrated into the processor 404. The processor 404 may be configured to execute computer-readable instructions stored in a memory (e.g., the memory 406) to cause the device 402 to perform various functions of the present disclosure.

The memory 406 may include random access memory (RAM) and read-only memory (ROM). The memory 406 may store computer-readable, computer-executable code including instructions that, when executed by the processor 404 cause the device 402 to perform various functions described herein. The code may be stored in a non-transitory computer-readable medium such as system memory or another type of memory. In some implementations, the code may not be directly executable by the processor 404 but may cause a computer (e.g., when compiled and executed) to perform functions described herein. In some implementations, the memory 406 may include, among other things, a basic I/O system (BIOS) which may control basic hardware or software operation such as the interaction with peripheral components or devices.

The I/O controller 410 may manage input and output signals for the device 402. The I/O controller 410 may also manage peripherals not integrated into the device M02. In some implementations, the I/O controller 410 may represent a physical connection or port to an external peripheral. In some implementations, the I/O controller 410 may utilize an operating system such as iOS®, ANDROID®, MS-DOS®, MS-WINDOWS®, OS/2®, UNIX®, LINUX®, or another known operating system. In some implementations, the I/O controller 410 may be implemented as part of a processor, such as the processor M06. In some implementations, a user may interact with the device 402 via the I/O controller 410 or via hardware components controlled by the I/O controller 410.

In some implementations, the device 402 may include a single antenna 412. However, in some other implementations, the device 402 may have more than one antenna 412 (i.e., multiple antennas), including multiple antenna panels or antenna arrays, which may be capable of concurrently transmitting or receiving multiple wireless transmissions. The transceiver 408 may communicate bi-directionally, via the one or more antennas 412, wired, or wireless links as described herein. For example, the transceiver 408 may represent a wireless transceiver and may communicate bi-directionally with another wireless transceiver. The transceiver 408 may also include a modem to modulate the packets, to provide the modulated packets to one or more antennas 412 for transmission, and to demodulate packets received from the one or more antennas 412.

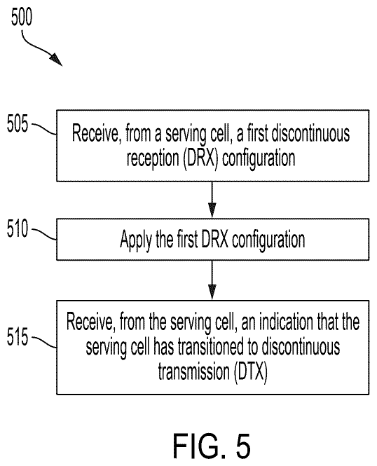

FIG. 5 illustrates a flowchart of a method 500 that supports modification of a UE DRX configuration in accordance with aspects of the present disclosure. The operations of the method 500 may be implemented by a device or its components as described herein. For example, the operations of the method 500 may be performed by the UE as described with reference to FIGS. 1 through 3. In some implementations, the device may execute a set of instructions to control the function elements of the device to perform the described functions. Additionally, or alternatively, the device may perform aspects of the described functions using special-purpose hardware.

At 505, the method may include receiving, from a serving cell, a first DRX configuration. The operations of 505 may be performed in accordance with examples as described herein. In some implementations, aspects of the operations of 505 may be performed by a device as described with reference to FIG. 1.

At 510, the method may include applying the first DRX configuration. The operations of 510 may be performed in accordance with examples as described herein. In some implementations, aspects of the operations of 510 may be performed by a device as described with reference to FIG. 1.

At 515, the method may include receiving, from the serving cell, an indication that the serving cell has transitioned to DTX. The operations of 515 may be performed in accordance with examples as described herein. In some implementations, aspects of the operations of 515 may be performed by a device as described with reference to FIG. 1.

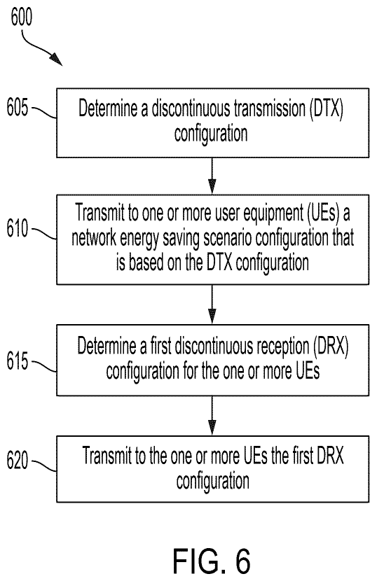

FIG. 6 illustrates a flowchart of a method 600 that supports providing UE DRX configurations in accordance with aspects of the present disclosure. The operations of the method 600 may be implemented by a device or its components as described herein. For example, the operations of the method 600 may be performed by the network, cell, or network entity as described with reference to FIGS. 1 through 3. In some implementations, the device may execute a set of instructions to control the function elements of the device to perform the described functions. Additionally, or alternatively, the device may perform aspects of the described functions using special-purpose hardware.

At 605, the method may include determining a discontinuous transmission (DTX) configuration. The operations of 605 may be performed in accordance with examples as described herein. In some implementations, aspects of the operations of 605 may be performed by a device as described with reference to FIG. 1.

At 610, the method may include transmitting to one or more UEs a network energy saving scenario configuration that is based on the DTX configuration. The operations of 610 may be performed in accordance with examples as described herein. In some implementations, aspects of the operations of 610 may be performed by a device as described with reference to FIG. 1.

At 615, the method may include determining a first DRX configuration for the one or more UEs. The operations of 615 may be performed in accordance with examples as described herein. In some implementations, aspects of the operations of 615 may be performed by a device as described with reference to FIG. 1.

At 620, the method may include transmitting to the one or more UEs the first DRX configuration. The operations of 620 may be performed in accordance with examples as described herein. In some implementations, aspects of the operations of 620 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A User Equipment (UE) for wireless communication, comprising:
at least one memory; and
at least one processor coupled with the at least one memory and configured to cause the UE to:
receive, from a serving cell, a first discontinuous reception (DRX) configuration;
apply the first DRX configuration;
receive, from the serving cell, a network energy saving scenario configuration that indicates a DTX configuration for the serving cell;
receive, from the serving cell via a radio resource control (RRC) signaling message, an indication that the serving cell has transitioned to discontinuous transmission (DTX); and
stop transmission to the serving cell based on the received indication.

2. The UE of claim 1, wherein the at least one processor is further configured to cause the UE to:
receive a second DRX configuration from the serving cell; and
apply the second DRX configuration in response to the indication.

3. The UE of claim 2, wherein the UE receives the first DRX configuration and the second DRX configuration via a single RRC signaling message.

4. The UE of claim 2, wherein the first DRX configuration and the second DRX configuration identifies a time period during which the UE is to be in an active reception mode.

5. The UE of claim 2, wherein applying the second DRX configuration includes not following the first DRX configuration when the serving cell is in a non-active transmission mode.

6. (canceled)

7. The UE of claim 1, wherein the UE is in a radio resource control (RRC) connected state.

8. The UE of claim 1, wherein the UE receives the indication that the serving cell has transitioned to discontinuous transmission (DTX) via a group common physical layer signaling using a specific radio network temporary identifier (RNTI).

9. The UE of claim 8, wherein the physical layer signaling triggers a start of one or more time periods in which the serving cell is in a non-active transmission mode.

10. The UE of claim 1, wherein the UE receives the indication that the serving cell has transitioned to discontinuous transmission (DTX) via physical layer signaling or a medium access control (MAC) control element (CE).

11. A processor for wireless communication, comprising:
at least one controller coupled with at least one memory and configured to cause the processor to:
receive, from a serving cell, a first discontinuous reception (DRX) configuration;
apply the first DRX configuration;
receive, from the serving cell, a network energy saving scenario configuration that indicates a DTX configuration for the serving cell;
receive, from the serving cell via a radio resource control (RRC) signaling message, an indication that the serving cell has transitioned to discontinuous transmission (DTX); and
stop transmission to the serving cell based on the received indication.

12. The processor of claim 11, wherein the at least one controller is further configured to cause the processor to:
receive a second DX configuration from the serving cell; and
apply the second DRX configuration in response to the indication.

13. The processor of claim 12, wherein the processor receives the first DRX configuration and the second DRX configuration via a single radio resource control (RRC) signaling message.

14. (canceled)

15. A network entity for wireless communication, comprising:
at least one memory; and
at least one processor coupled with the at least one memory and configured to cause the network entity to:
transmit to one or more user equipment (UEs) a network energy saving scenario configuration that is based on a discontinuous transmission (DTX) configuration;
transmit to the one or more UEs the DTX configuration.

16. The network entity of claim 15, wherein the at least one processor is configured to cause the network entity to:
determine a DRX configuration for the one or more UEs; and
transmit to the one or more UEs the DRX configuration.

17. The network entity of claim 16, wherein the DRX configuration is based on the DTX configuration.

18. The network entity of claim 15, wherein the at least one processor is configured to cause the network entity to:
transmit, to the one or more UEs, physical layer signaling to trigger starts of time periods when the network entity is in a non-active transmission mode based on the DTX configuration.

19. A method performed by a network entity, the method comprising:
transmitting to one or more user equipment (UEs) a network energy saving scenario configuration that is based on a discontinuous transmission (DTX) configuration;
and
transmitting to the one or more UEs the DTX configuration.

20. The method of claim 19, further comprising:
determining a DRX configuration for the one or more UEs; and
transmitting to the one or more UEs the DRX configuration.

21. The method of claim 19, further comprising:
transmitting, to the one or more UEs, physical layer signaling to trigger starts of time periods when the network entity is in a non-active transmission mode based on the DTX configuration.
